(19) United States
(12) Patent Application Publication
(10) Pub. No.: US 2015/0127957 A1
(43) Pub. Date: May 7, 2015

(54) ADAPTIVE INLINE POWER MANAGMENT SYSTEM

(71) Applicant: Cisco Technology, Inc., San Jose, CA (US)

(72) Inventor: Kabiraj Sethi, San Jose, CA (US)

(73) Assignee: Cisco Technology, Inc., San Jose, CA (US)

(21) Appl. No.: 14/073,161

(22) Filed: Nov. 6, 2013

(51) Int. Cl. G06F 1/26

(52) U.S. Cl. CPC G06F 1/26
USPC 713/300

(57) ABSTRACT

In an embodiment, a system can include a temperature sensor configured to sense a temperature at a part of the system, resulting in temperature data. The system can also include a power source configured to provide power and network data to a powered device circuit. The powered device circuit may be configured to provide the power and the network data to a powered device. The system may also include a current limiting module configured to maintain a maximum limit of current drawn from the power source by the powered device circuit, and a control module configured to control the current limiting module to adjust the maximum limit of the current drawn from the power source by the powered device circuit, according to the temperature data.

### TECHNICAL FIELD

The present disclosure relates to adaptive inline power management systems, such as adaptive inline Power over Ethernet management systems.

### BACKGROUND

Power over Ethernet (PoE) systems may include any standardized or ad-hoc systems that pass electrical power along with data on Ethernet lines. This allows a line to provide both data connection and electrical power to devices. Using PoE, power may be conducted on the same medium as data or there may be dedicated conductors within a same line. This lends PoE to power management, since a line providing power can also be a line for controlling the power via control information separate from the provided power.

### BRIEF DESCRIPTION OF THE DRAWINGS

FIG. 1 illustrates a block diagram of an example adaptation of an example embodiment of an adaptive inline power management system (AIPMS).

FIG. 2 illustrates a block diagram of example modules of example powered device and power source equipment (PD-PSE) of the AIPMS of FIG. 1.

FIG. 3 illustrates a block diagram of example operations of an example embodiment of the AIPMS, such as adjusting power levels to powered devices according to available power and temperature levels in the system.

FIG. 4 illustrates a block diagram of example operations of an example embodiment of the AIPMS, such as maintaining and resetting the current limits for uplink powered device circuits.

FIG. 5 illustrates a block diagram of example operations of an example embodiment of the AIPMS, such as load shedding and increasing power budget according to temperature levels of the system.

FIG. 6 illustrates a block diagram of an example computational node of an example embodiment of the AIPMS.

### DESCRIPTION OF EXAMPLE EMBODIMENTS

### Overview

In an embodiment, a system can include a temperature sensor configured to sense a temperature at a part of the system, resulting in temperature data. The system may also include a power source configured to provide power and network data to a powered device circuit. The powered device circuit may be configured to provide the power and the network data to a powered device. The system may also include a current limiting module configured to maintain a maximum limit of current drawn from the power source by the powered device circuit, and a control module configured to control the current limiting module to adjust the maximum limit of the current drawn from the power source by the powered device circuit, according to the temperature data.

In another embodiment, an apparatus may include a data communications interface configured to receive temperature data corresponding to a sensed temperature at a part of powered device and power sourcing equipment. The apparatus may also include a first power and data communications interface configured to receive power and data and direct the power and the data to a second power and data communications interface. Also, the apparatus may include a current limiting module configured to limit current received at the first power and data communications interface according to the temperature data, and as a result limit the directed power.

In another embodiment, a method may include receiving, from a temperature sensor, a temperature at one or more of parts of power sourcing equipment and a plurality of powered devices, resulting in temperature data. The method may also include receiving Power over Ethernet at a first powered device circuit via a first uplink power source port. The first powered device circuit may be configured to provide at least part of the Power over Ethernet to a first powered device of the plurality of powered devices via a first downlink power source port. Also, the method may include receiving the Power over Ethernet at a second powered device circuit via a second uplink power source port. The second powered device circuit may be configured to provide at least part of the Power over Ethernet to a second powered device of the plurality of powered devices via a second downlink power source port. Also, the method may include limiting, by a current limiting module, current drawn from the power source by the first powered device circuit and the second powered device circuit. The method may also include determining, by a load balancing module, a first load of the first powered device and a second load of the second powered device, resulting in load balancing data, and controlling, by a control module, the limiting of the current drawn from the power source by the first powered device circuit and the second powered device circuit, per circuit, according to the load balancing data and the temperature data.

### EXAMPLE EMBODIMENTS

Various embodiments described herein can be used alone or in combination with one another. The following detailed description describes only a few of the many possible implementations of the present embodiments. For this reason, this detailed description is intended by way of illustration, and not by way of limitation.

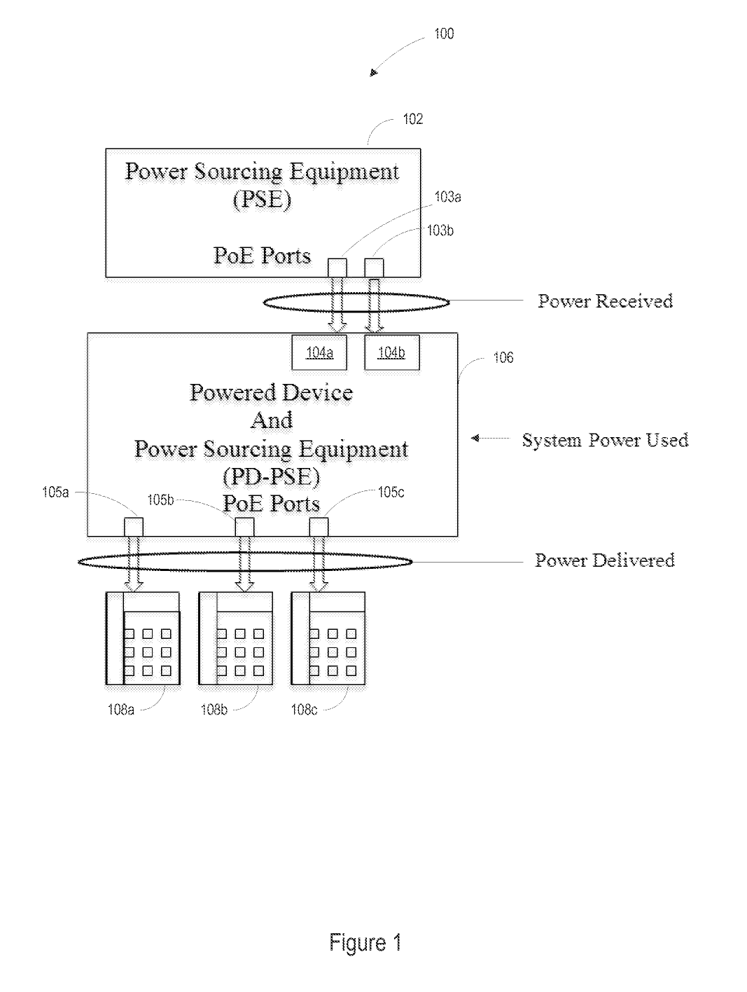

FIG. 1 illustrates a block diagram of an example adaptation of an example embodiment of the adaptive inline power management system (AIPMS). FIG. 1 illustrates power sourcing equipment 102, which includes uplink power source ports 103a and 103b, which may be uplink ports that can also communicate data, such as uplink Power over Ethernet (PoE) ports. These uplink power source ports can communicate power and/or data, such as network data or application data, to uplink powered device (PD) circuits 104a and 104b. FIG. 1 illustrates the uplink PD circuits 104a and 104b as being a part of PD-PSE 106. The PD-PSE 106 also includes downlink power source ports 105a, 105b, and 105c for communication with the PDs 108a, 108b, and 108c. These downlink power source ports may be downlink PoE source ports that are also capable of communicating data, such as application data or network data over a network.

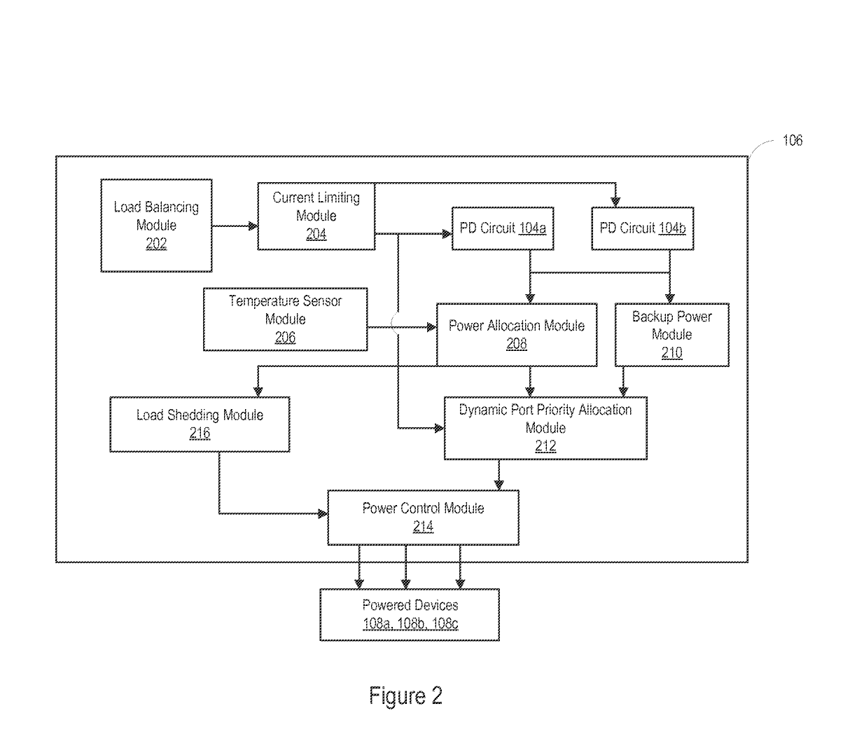

FIG. 2 illustrates a block diagram of modules of an example PD-PSE of the AIPMS of FIG. 1, which includes the uplink PD circuits 104a and 104b. Uplink PD circuits 104a and 104b may include PoE devices, such as standardized PoE devices based on IEEE standard Power over Ethernet standards. The PD-PSE 106 may also include a load balancing module 202. The load balancing module 202 may include instructions to output load balancing information to a current limiting module 204 to balance the load of the PD circuits 104a and 104b. The current limiting module 204 may limit the maximum current that can be drawn by the uplink PD circuits 104a and 104b. The PD-PSE 106 may also include a temperature sensor module 206 that includes temperature sensors that can measure ambient temperature within the device and output thermal data, such as to a power allocation module 208. The power allocation module 208 may include a PoE allocation module, and may implement power budget distribution instructions. The PD-PSE 106 may also include a backup power module 210. The backup power module 210 dynamically calculates and keeps account of the available backup power budget received from the uplink PD circuits 104a or 104b, when a one of the power sources is removed, such as removed from the power sourcing equipment 102. The PD-PSE 106 may also include a dynamic port priority allocation module 212 that takes data input from the backup power module 210, the current limiting module 204, and the power allocation module 208 to decide the priority of PDs 108a, 108b, and 108c dynamically. The PD-PSE 106 may also include a power control module 214, such as PoE control module, which sources power to PDs 108a, 108b, and 108c. The PD-PSE 106 may also include a load shedding module 216 that can remove power, starting from a low priority PD, when the total power budget goes below total available power. As depicted, the load balancing module 202 provides load balancing data to control the current limiting module 204, which limits current received by the uplink PD circuits 104a and 104b. The power outputted by the uplink PD circuits 104a and 104b is received by the power allocation module 208 and the backup power module 210, that outputs backup power information to the dynamic port priority allocation module 212. The dynamic port priority allocation module 212 outputs priority power information to the power control module 214, which controls power output to PDs, such as the PDs 108a, 108b, and 108c. Also, as depicted, the power allocation module 208 provides power allocation data, such as system feedback PoE allocation data, to the load balancing module 202, the load shedding module 216, and the dynamic port priority allocation module 212. The load shedding module 216 provides load shedding data to instruct load shedding by the power control module 214 when circumstances arise. Also, besides power communicated from the circuits 104a and 104b, the power allocation module 208 receives temperature sensor output temperature data from the temperature sensor module 206.

In an example embodiment, one or more of input and/or output data interfaces for the modules of the PD-PSE, such as one or more input and/or output data interfaces for the modules of the PD-PSE 106, can also be configured to receive and/or transmit power. For example, one or more modules of the PD-PSE may include respective uplink power and data communication ports and/or downlink power and data communication ports, such as PoE uplink and downlink ports.

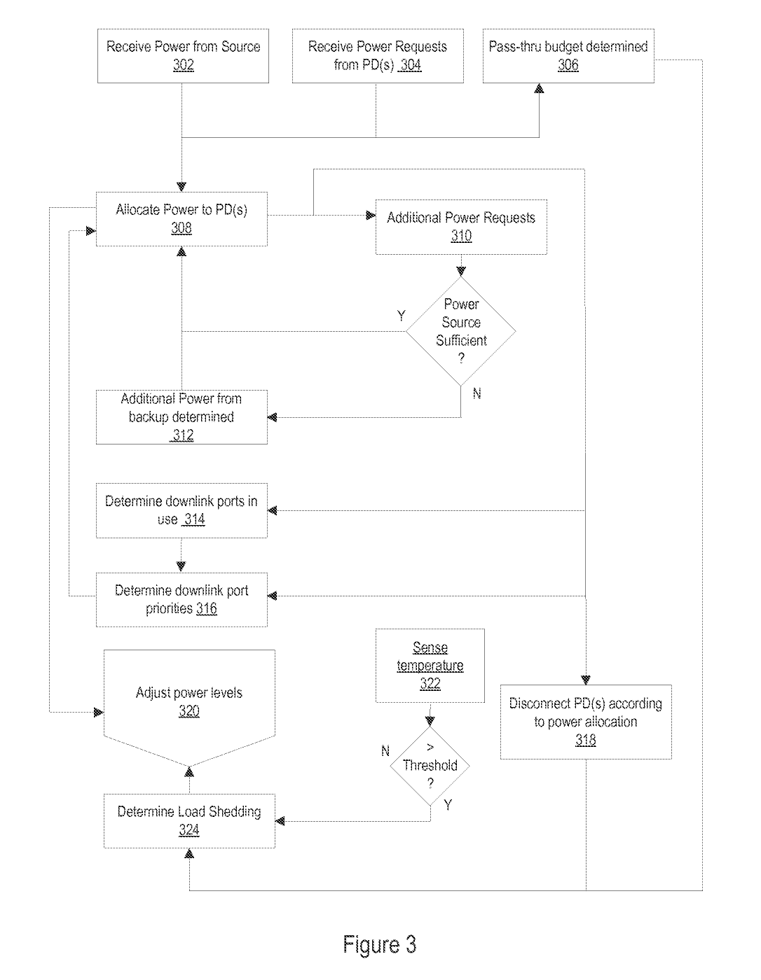

FIGS. 3-5 illustrate block diagrams of example operations of an example embodiment of the AIPMS of FIG. 1. For example, FIG. 3 illustrates adjusting power levels to powered devices according to available power and temperature levels in the AIPMS.

At 302, the PD-PSE 106 receives power from power sourcing equipment 102 at the uplink power source ports 103a and 103b. These ports may be set with a default current limit, default I_{LIM}, at the current limiting module 204, which may be a maximum current for a predetermined type of PoE port, such as a Type 1 PoE port, which is further described later. The I_{LIM} may be the maximum current draw limit that can be attained for a configuration of PDs. PDs, such as PDs 108a, 108b, and 108c, at 304, may use one or more power negotiation protocols to make power requests to the PD-PSE 106, such as over the downlink power source ports 105a, 105b, and 105c. At 306, a power pass-thru budget for a PD may be calculated by the power allocation module 208 according to total power used to power up a power transfer device and power loss during transmission to a PD, such as according to Formula 1.

Pₚₐₛₛ₋ₜₕᵣᵤ=ΣP_{PDi}(i=1,2)−P_{device}−Pₗₒₛₛ; (1)
P_{device} being a total power used to power up a power transfer device;
Pₗₒₛₛ being power loss during transmission;
ΣP_{PDi} (i=1, 2) being a sum total of power received by a uplink PD₁ circuit, such as uplink PD circuit 104a, and uplink PD₂ circuit, such as uplink PD circuit 104b; and
Pₚₐₛₛ₋ₜₕᵣᵤ being an amount of power budget for downlink power source ports 105 after deducting the system consumption, P_{device}, and transmission loss, Pₗₒₛₛ, from the total power received by uplink PD circuits.

At 308, the power allocation module 208 may allocate a power budget for the PDs and provide power to the PDs via the power control module 214 and the downlink power source ports 105a, 105b, and 105c. The power may be allocated when the PDs are connected to the downlink power source ports 105a, 105b, and 105c of the PD-PSE 106. At 310, the power allocation module 208 can determine and notify additional power allocated to load balancing module 202 which calculates the ΔI_{LIM} (change in I_{LIM} duty cycle) needed by a new PD. The result of this determination can be communicated to the current limiting module 204, which can adjust the ΔI_{LIM} to control the current drawn by the PD-PSE 106, such as the current drawn at uplink PD circuits 104a and 104b. At 312, the power allocation module 208 can determine backup power budget (B) that can be supplied from one of the remaining power sources, such as via uplink PD circuits 104a and 104b. The determination of B can be based on available power at any given time after losing one of the power sources from the power sourcing equipment.

At 314, the power allocation module 208 identifies a downlink power source port, such as one of downlink power source ports 105a, 105b, and 105c, that has a PD recently connected to it. At 314, the power allocation module 208 may also identify the power allocated to data communication ports, such as data communication ports of the PD-PSE 106. In some embodiments, the data communication ports may be the same ports as the power source ports, such as is the case with PoE ports. In an example using PoE, the data communication ports may be the same ports as the downlink power source ports. At 316, the dynamic port priority allocation module 212 can determine relative priority of the downlink power source ports according to a backup power budget and a total amount of power allocated to PDs connected to the ports, such as according to formula 2.

Priority=“high”, if B−ΣPₚₒᵣₜ≧0, else “low”; (2)
B being calculated backup power budget, such as a budget determined at the backup power module 210;
Σpₚₒᵣₜ being a sum total of power allocated to connected PDs, such as PDs 108a, 108b, and 108c; and
Priority being a high or low priority, wherein a low priority PD is removed first if total available power drops below the total determined power allocation, such as determined at the power allocation module 208.

At 318, the power control module 214 can check power allocation to the connected PDs and disconnect PDs, accordingly, such as disconnecting starting from higher numbered ports connected to the PDs. At 320, from a determined pass-thru power level at 306, the control module 214 can adjust power allocated to the PDs. At 320, the control module 214 can also adjust power according to the power allocated at 308. Also, new port priorities can be determined, such as at 316, according to the pass-thru power level. The checking of power allocation and disconnecting of PDs may occur upon removal of any uplink power source ports, such as any of the uplink power source ports 103a and 103b.

At 322, the temperature sensor module 206 may check for an increase in temperature of the power source, the PD-PSE, and/or a PD by receiving information from temperature sensors included in the PD-PSE, and/or receiving temperature data that includes temperature sensor readings via the uplink and/or downlink ports. Also, temperature at one or more specific points of the power source, the PD-PSE, and/or a PD may be checked. Where increase above a predetermined or provided threshold temperature is detected, the control module 214 may trigger a load shedding determination controlled by the load shedding module 216, at 324. Alternatively, or in addition, current limiting may occur. Such an increase above the threshold temperature may also trigger re-determination of the pass-thru power allocation, re-assignments of downlink power source port priority, and re-adjustment of I_{LIM} drawn by the uplink PD circuits.

In an example embodiment, an aspect of the PD-PSE, such as power allocation module 208, may adjust a PD's inline power budget dynamically according to power availability from connected power sources. The adjustment may also be according to a number of power sources connected and/or detected temperatures at one or more points of the PD-PSE, the PD, and/or the power source. The aspect, such as the dynamic port priority allocation module 212, may dynamically assign priority to the PDs to reduce the number of PDs using power from the connected power sources. In such an example, load balancing may occur via dynamic adjustments to current limits on uplink PD circuits, according to system feedback. The dynamic port priority aspect, such as port priority allocation module 212, may determine power to be consumed by one or more PDs according to Formula 3.

ΣP_{PDi}=P_{system}_{_{—}}ₘₐₓ_{_{—}}ₜₑₘₚ+Pₗₒₛₛ+Pₚₐₛₛ₋ₜₕᵣᵤ; (3)
ΣP_{PDi} being a sum total of power received on uplink PD circuits, such as uplink PD circuits 104a and 104b;
ΣP_{system}_{_{—}}ₘₐₓ_{_{—}}ₜₑₘₚ being power consumed by the system at a maximum sustainable temperature;
Pₗₒₛₛ being power loss due to transmission and internal hardware power drop; and
Pₚₐₛₛ₋ₜₕᵣᵤ being an amount of power budget for PDs after deducting the system consumption, P_{system}_{_{—}}ₘₐₓ_{_{—}}ₜₑₘₚ, and Pₗₒₛₛ from the total power received by the uplink PD circuits.

P_{PDi} may represent determined power budget for power received from an assigned uplink power source port for one or more PDᵢ using the PD-PSE. P_{system}_{_{—}}ₘₐₓ_{_{—}}ₜₑₘₚ may represent a maximum amount of power that can be drawn by the PD-PSE when the temperature at a point of the PD-PSE, the PD, or the power source is at a determined maximum, such as 85 degrees Celsius. Pₗₒₛₛ, derived from power loss data, may represent the maximum power loss during transfer of power through the PD-PSE. Pₚₐₛₛ₋ₜₕᵣᵤ may represent power available to the PDᵢ of the set of PDs.

In an example embodiment, a total power pass-thru budget, such as a PoE pass-thru budget, may be determined for the PD-PSE and may change dynamically to prevent extraneous loss and damage to hardware of the PD-PSE. Drawing of power from multiple devices may be controlled via load shedding logic, such as instructions in the load shedding module 216. The load shedding logic may control reducing power of power source devices, such as PoE source devices, when there is too much power being consumed according to one or more monitoring aspects of the PD-PSE, such as temperature sensor module 206. For example, if the temperature is too high, then too much power is being consumed.

Downlink power source port priorities may be matched to the power source devices, which represent power sources to be powered down first if there is too much power being consumed. When load shedding occurs, the PD-PSE may limit power to low priority downlink power source ports first. The dynamic adjustment of load shedding and port priority may be determined based on available backup power, such as the power available budget data at the power backup module 210. Load shedding may occur according to each individual PD load budget and PD port priority of a set of connected PDs. In an example embodiment, during booting up of the PD-PSE with no PDs connected yet to the PD-PSE, downlink ports of the PD-PSE may all be set at a high priority. Priority then may be changed automatically when PDs are added and/or removed from the downlink power source ports, such as by the power control module 214. This prioritization may be based on priority data and/or respective PD load budgets of the connected PDs, which may include available backup power data and respective port numbers for each connected PD.

Alternatively or additionally, in cases of a PoE PD-PSE, the power pass-thru budget can be modified by Universal PoE (UPoE) support. For example, budgets for UPoE supported uplink PD circuits can be modified, so that uplink power source ports, connected to the uplink PD circuits, can act as different types of PoE uplink ports, such as Type 1 or Type 2 ports. One example difference between types of uplink power source ports is power level capability and/or demand from the uplink PD circuits. The type of each uplink power source port can be changed dynamically by an aspect of the PD-PSE without manufactured or manual changes to PD-PSE hardware, such as by a part of an uplink PD circuit.

In an example embodiment, UPoE may be supported on all 4-pairs of an RJ45 cable, and power is divided amongst signal and spare pairs. When one of the uplink power source ports becomes UPoE after power negotiation, another uplink power source port can act merely as data link, for example. In UPoE support, load shedding priorities may be recalculated and assigned in a dynamic manner every time a PD device is connected or disconnected to the downlink power source ports or whenever the power source type or value changes in the uplink power source ports. For example, such recalculations may occur when an uplink power source port negotiates with uplink power source equipment to change from one type of port to another type of port, a downlink power source port is disconnected from a PD, and/or an auxiliary power source is removed. Table 1 shows example pass-thru power alternatives and port priorities. In Table 1, T1 represents a Type 1 port according to PoE IEEE 802.3af Ports, and T2 represents a Type 2 port according to PoE+ or PoE Plus IEEE 802.3at Ports. UPoE may include a data communication line, such as an RJ45 line, with spare pairs and signal pairs providing a predetermined amount of pass through power, such as 60 Watts of pass-thru power. The UPoE provided power may be negotiated by the uplink and/or downlink ports using discovery protocols, such as Link Layer Discovery Protocol (LLDP) and/or Cisco Discovery Protocol (CDP) communicated over the network to the uplink and/or downlink ports. For example, the spare-pair discovery may occur using, for example, CDP and LLDP type-length-values (TLVs), such as a proprietary protocol.

TABLE 1

| | | | | High Priority |
|---|---|---|---|---|
| | | Pass-Thru | Back-Up | Port (Always |
| AUX | | Power Budget | Power | low numbered |
| Power | Power Sources | (Watts) | (Watts) | ports first) |
| None | T1 + None Or | 0 | 0 | None |
| | None + T1 | | | |
| None | T1 + T1 | 7 | 0 | None |
| None | T1 + T2 or | 15.4 | 0 | None |
| | T2 + T1 | | | |
| None | T2 + None | 7 | 0 | None |
| | None + T2 | | | |
| None | T2 + T2 | 22.4 | 7 | One 7 Watts |
| | | | | lowest num- |
| | | | | bered port |
| | | | | made high |
| | | | | priority |
| None | UPoE + None | 30.8 | 0 | None |
| Present | T1 + None Or | 22.4 | 0 | None |
| | None + T1 | | | |
| Present | T1 + T1 | 22.4 | 7 | One 7 watts |
| | | | | lowest num- |
| | | | | bered port |
| | | | | made high |
| | | | | priority |
| Present | T1 + T2 or | 22.4 | 15.4 | One 15.4 W |
| | T2 + T1 | | | port or two |
| | | | | 7 W ports |
| Present | T2 + None | 22.4 | 7 | One 7 W port |
| | None + T2 | | | |
| Present | T2 + T2 | 22.4 | 22.4 | 2 ports (7 W + |
| | | | | 15.4 W) or 3 |
| | | | | Ports (7 W + |
| | | | | 7 W + 7 W) |
| Present | UPoE + None | 30.8 | 30.8 | 2 ports (15.4 |
| | | | | W + 15.4 W) |
| | | | | or 3 ports (7 |
| | | | | W + 7 W + |
| | | | | 15.4 W) or 4 |
| | | | | ports (7 W + |
| | | | | 7 W + 7 W + |
| | | | | 7 W) |

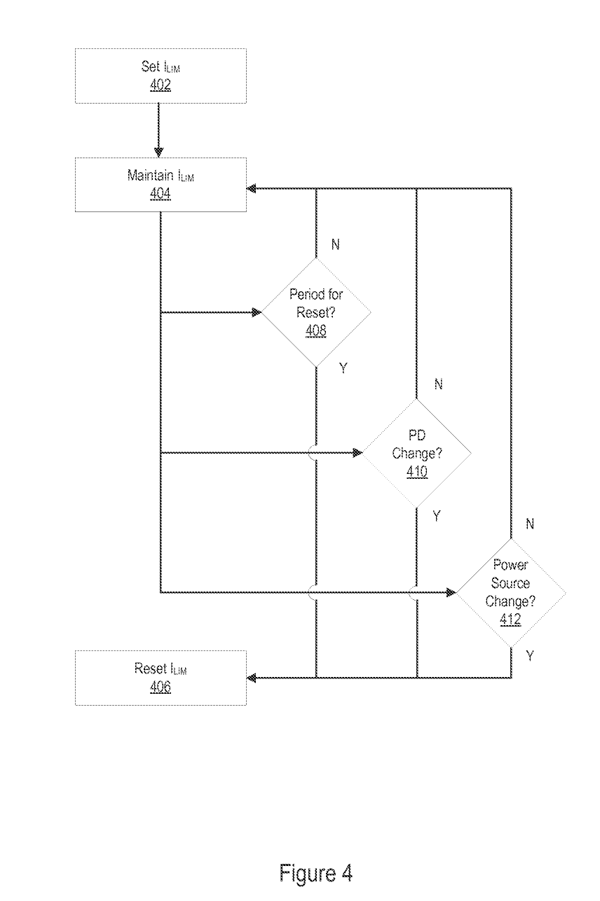

FIG. 4 illustrates a block diagram of example operations performed by aspects of the AIPMS, such as maintaining and resetting the current limits for uplink PD circuits. For example, a PD-PSE, such as PD-PSE 106, may include at least two uplink PD circuits, such as uplink PD circuits 104a and 104b, that draw power from power sourcing equipment, such as the power sourcing equipment 102, to power a switching device for load balancing. Any excess power may be passed through downlink power source ports to PDs. The uplink PD circuits may comply with predetermined standards for power usage, such as PoE standards including IEEE 802.3af and/or 802.3at. Powered transferred from one uplink power source port to another in event of loss of one inline power source is more reliable when PD-PSE load is distributed evenly amongst downlink power source ports. The load balancing can be achieved on the downlink power source ports by setting up I_{LIM} in a stepwise routine, such as in a stepwise routine between the power control module 214 and the load balancing module 202.

At 402, a load balancing aspect, such as load balancing module 202, may set a current limit, I_{LIM}, such as at current limiting module 204, to facilitate restriction of current drawn by an uplink PD circuit. An I_{LIM} setting may be maintained at 404 or reset at 406. The I_{LIM} can be reset periodically (see 408), reset upon a PD addition and/or removal (see 410), and/or reset upon any change in an uplink power source (see 412), such as a change in the type of source and/or negotiated power levels, via a power control module (such as the power control module 214). The I_{LIM} can be maintained so that the differences between current limits per uplink PD circuit are minimal and/or the limits meet power usage standards, such as PoE standards.

In an example embodiment, the I_{LIM}, set at 402, may occur according to voltage at the power sourcing equipment power interface, a power allocation level for a PD, and line resistance, such as in accordance with Formula 4.

$${I}_{LIM} = \frac{{V}_{PSE} - \sqrt{{V}_{PSE}^{2} - 4 {R}_{chan} {P}_{class \_ PD}}}{2 {R}_{chan}} \qquad ( 4 )$$

V_{PSE} being voltage at the power sourcing equipment power interface;
R_{chan} being channel resistance or line resistance;
P_{claas}_{_{—}}_{PD} being power sourcing equipment power allocation value, such as a IEEE standardized value, for a PD device of a specific class; and
I_{LIM} being a current allowed to be drawn by an uplink PD circuit.

Table 2 shows device power source peak power limits in Watts, for a PD-PSE including two uplink PD circuits and an auxiliary power source.

TABLE 2

Type

| Signal | 1 | 2 |
|---|---|---|
| PD1 | 14.4 | 28.3 |
| PD2 | 14.4 | 28.3 |

| | |
|---|---|
| AUX | 56.6 |

The Watts calculated for the uplink PD circuits determine the I_{LIM}. Power consumed by a PD determines the current usage of a P_{class}_{_{—}}_{PD}. Pulse Width Modulation (PWM) can be used to control I_{LIM}_{_{—}}_{pwm} and related sub-circuits for digital to analog conversion and analog to digital conversion. In an example, I_{LIM} may be determined by Formulas 5-8, wherein the I_{LIM} may be set prior to a load being powered on.

$$\begin{matrix} {I}_{LIM} = {I}_{min} + {I}_{duty \_ cycle} \\ {I}_{min} being a baseline current value & ( 5 ) \\ Duty cycle = ( ( {I}_{LIM} - {I}_{min} ) / {I}_{max \_ duty \_ cycle} ) , when {I}_{LIM} > {I}_{min} \\ {I}_{max \_ duty \_ cycle} being a current ( I ) when duty cycle is at 100 \% ; & ( 6 ) \\ {P}_{minimum} for Duty cycle = {I}_{min} \times {V}_{minimum} + ( {I}_{max \_ duty \_ cycle} \times ( duty cycle = 0 \% ) ) = {I}_{min} \times {V}_{minimum} & ( 7 ) \\ {P}_{maximum} for Duty cycle = {I}_{min} + ( {I}_{max \_ duty \_ cycle} \times ( duty cycle = 100 \% ) ) \times {V}_{minimum} = {I}_{min} * {V}_{minimum} + {I}_{max \_ duty \_ cycle} \times {V}_{minimum} ; \\ {V}_{minimum} being an allowed minimum voltage ; \\ and \\ {P}_{maximum} being a power possible with a maximum duty cycle and a minimum voltage . & ( 8 )\end{matrix}$$

The duty cycle of the I_{LIM}_{_{—}}_{PWM} may incremented or decremented by comparing both PD types and the value of I_{LIM} determined by each uplink PD circuit until differences between I_{LIM} duty-cycles between PDs is minimized to a predetermined level.

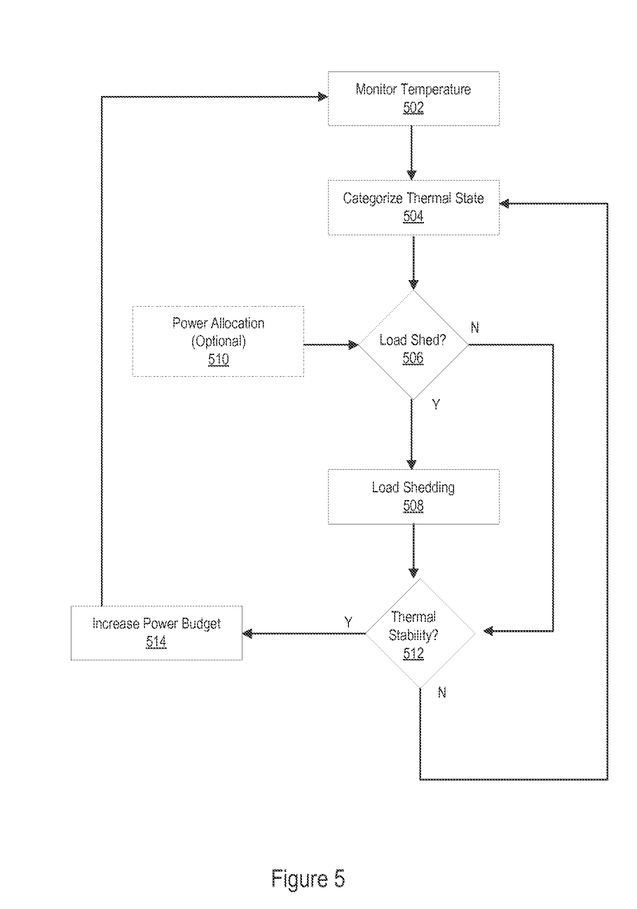

FIG. 5 illustrates a block diagram of example operations including load shedding and increasing power budget according to temperature levels of the AIPMS. For example, a PD-PSE, such as PD-PSE 106, may include the temperature sensor module 206 and the power allocation module 208 to provide such power budget management. Such management is useful, for example, in event of temperature increase in an environment of the PD-PSE. Switches of a PD-PSE may be fan-less compact switches that may be affected by temperature fluctuations that occur for various reasons. A software mechanism to monitor temperature of the PD-PSE and act accordingly to maintain temperature levels below determined temperature thresholds may increase the stability in the PD-PSE. An example action to reduce temperature in the PD-PSE may include reducing a pass-thru power budget to compensate for a rise in temperature. Low priority PDs may get shedded when power budget is reduced. Priority of PDs may be determined by current operations of a PD. For example, some operations may be priority operations.

In an example embodiment, the one or more aspects of the PD-PSE may be controlled by a micro-controller unit (MCU), analog to digital converter (ADC), and a temperature sensor, which can have an output measurable by the ADC. The ADC in such an example may be configured to obtain measurements at a high data rate. Also, temperature measurements may be sensed from one or more positions of the PD-PSE and Formula 9 can be used to determine temperature change per bit.

$$Temp / bit = \frac{TempHigh - TempLow}{ValueHigh - ValueLow} \qquad ( 9 )$$

In an example, the one or more aspects may monitor temperature levels of the PD-PSE, at 502, and categorize findings according to determined categories of thermal state, at 504, such as GREEN (Normal), YELLOW (Warning) and RED (Critical). In such an example, GREEN may be below 40 degrees Celsius, YELLOW may be >=40 and <55 degrees Celsius, and RED>=55 degrees Celsius. In such an example, at various thermal levels, one or more modules, such as the temperature sensor module 206 and/or the power allocation module 208, may monitor and determine whether to load shed devices to bring the PD-PSE to a predefined thermal stability, at 506. Such a determination may be according to categories related to temperature levels, such as Normal, Warning, and Critical. At 508, load shedding may occur according to the determinations at 506.

Additionally or alternatively, when power budget is updated, some PDs, such as PoE PDs, may be disconnected depending upon power allocation determined at 510. The load shedding of PDs may begin with higher number ports. Upon adjustment of thermal conditions, power budget may be increased and disconnected devices may be connected and powered up at 514, depending on whether the thermal state of the PD-PSE is stable, at 512, for example.

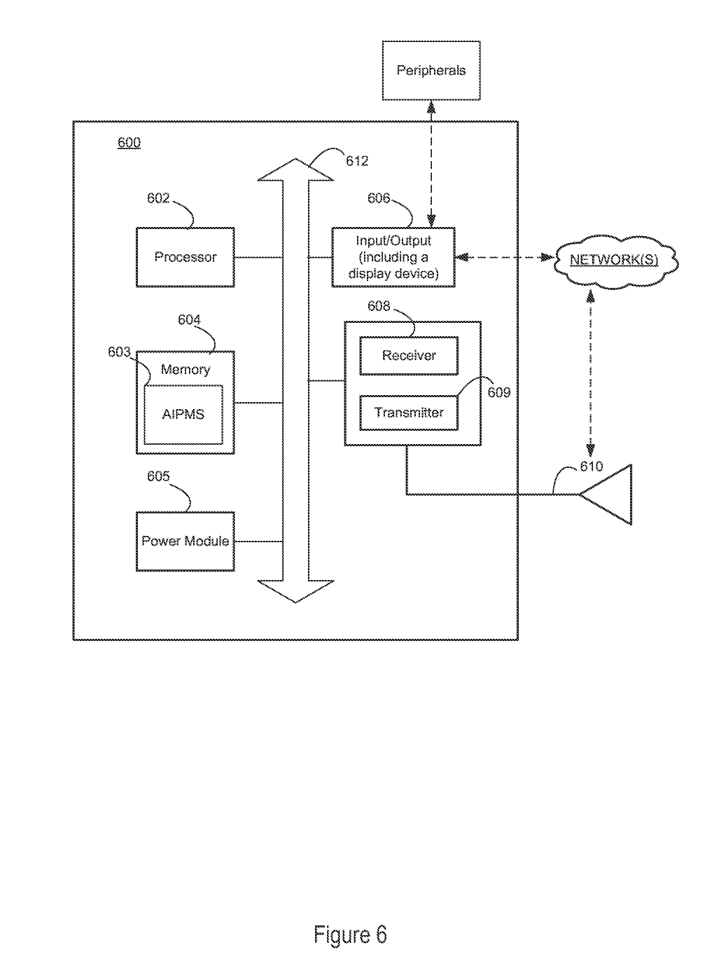

FIG. 6 illustrates a block diagram of an example computational node 600 of example embodiment of the AIPMS of FIGS. 1 and 2. Instances of the computational node 600 may be any device or any computational module of the adaptation 100 (such as the load balancing module 202, the power allocation module 208, the dynamic port priority allocation module 212, the power control module 214, and the load shedding module 216) or any device capable of becoming a computational node of the system. The computational node 600, which can be a combination of multiple electronic devices, may include a processor 602, memory 604, a power module 605, input/output (I/O) 606 (including input/out signals, one or more display devices, one or more sensors, and internal, peripheral, user, and network interfaces), a receiver 608 and a transmitter 609 (or a transceiver), an antenna 610 for wireless communications, and/or a communication bus 612 that connects the aforementioned elements of the computational node 600. The processor 602 can be one or more of any type of processing device, such as a central processing unit (CPU). Also, for example, the processor 602 can be central processing logic; central processing logic may include hardware and firmware, software, and/or combinations of each to perform function(s) or action(s), and/or to cause a function or action from another component. Also, based on a desired application or need, central processing logic may include a software controlled microprocessor, discrete logic such as an application specific integrated circuit (ASIC), a programmable/programmed logic device, memory device containing instructions, or the like, or combinational logic embodied in hardware. In any of these examples, hardware and/or software instructions, such as AIPMS instructions 603 included in the memory 604, may implement example aspects of the AIPMS. The memory 604, such as RAM or ROM, can be enabled by one or more of any type of memory device, such as a primary (directly accessible by the CPU) or a secondary (indirectly accessible by the CPU) storage device (e.g., flash memory, magnetic disk, optical disk). The power module 605 contains one or more power components, and facilitates supply and management of power to the computational node 600. The input/output 606, can include any interface for facilitating communication between any components of the computational node 600, components of external devices (such as components of other devices of the adaptation 100), and users. For example, such interfaces can include a network card that is an integration of the receiver 608, the transmitter 609, and one or more I/O interfaces. The network card, for example, can facilitate wired or wireless communication with other nodes of the adaptation 100. In cases of wireless communication, the antenna 610 can facilitate such communication. Also, the I/O interfaces can include user interfaces, such as monitors, displays, keyboards, keypads, touchscreens, microphones, and speakers. Further, some of the I/O interfaces and the bus 612 can facilitate communication between components of the computational node 600, and in some embodiments ease processing performed by the processor 602. In other examples of the computational node 600, one or more of the described components may be omitted.

Various embodiments described herein can be used alone or in combination with one another. The foregoing detailed description has described only a few of the many possible implementations of the present embodiments. For this reason, this detailed description is intended by way of illustration, and not by way of limitation.

Furthermore, the separating of example embodiments in operation blocks or modules described herein or illustrated in the drawings is not to be construed as limiting these blocks or modules as physically separate devices. Operational blocks or modules illustrated or described may be implemented as separate or combined devices, circuits, chips, or computer readable instructions.

Each module described herein is hardware, or a combination of hardware and software. For example, each module may include and/or initiate execution of an application specific integrated circuit (ASIC), a Field Programmable Gate Array (FPGA), a circuit, a digital logic circuit, an analog circuit, a combination of discrete circuits, gates, or any other type of hardware, or combination thereof. Accordingly, as used herein, execution of a module by a processor can also refer to logic based processing by the module that is initiated directly or indirectly by a processor to complete a process or obtain a result. Alternatively or in addition, each module can include memory hardware, such as at least a portion of a memory, for example, that includes instructions executable with a processor to implement one or more of the features of the module. When any one of the modules includes instructions stored in memory and executable with the processor, the module may or may not include the processor. In some examples, each module may include only memory storing instructions executable with a processor to implement the features of the corresponding module without the module including any other hardware. Because each module includes at least some hardware, even when the included hardware includes software, each module may be interchangeably referred to as a hardware module.

Each module may include instructions stored in a non-transitory computer readable medium, such as memory 604 of FIG. 6, that may be executable by one or more processors, such as processor 602 of FIG. 6. Hardware modules may include various devices, components, circuits, gates, circuit boards, and the like that are executable, directed, or controlled for performance by the processor 602. Further, modules described herein may transmit or received data via communications interfaces via a network, such as or including the Internet. Also, the term “module” may include a plurality of executable modules.

What is claimed is:

1. A system, comprising:
a temperature sensor configured to sense a temperature at a part of the system, resulting in temperature data;
a power source configured to provide power and network data to a powered device circuit, the powered device circuit configured to provide the power and the network data to a powered device;
a current limiting module configured to maintain a maximum limit of current drawn from the power source by the powered device circuit; and
a control module configured to control the current limiting module to adjust the maximum limit of the current drawn from the power source by the powered device circuit, according to the temperature data.

2. The system of claim 1, wherein:
the powered device circuit is a first powered device circuit and the powered device is a first powered device,
the system further comprises a second powered device circuit and a load balancing module,
the second powered device circuit is configured to receive the power and the network data from the power source and to provide at least part of the power and at least part of the network data to a second powered device,
the load balancing module is configured to determine a first load of the first powered device and a second load of the second powered device according to the at least part of the network data, resulting in load balancing data, and
the control module is further configured to control the current limiting module to adjust the maximum limit of the current drawn from the power source by the first powered device circuit and the second powered device circuit, according to the load balancing data and the temperature data.

3. The system of claim 1, wherein:
the powered device circuit is a first powered device circuit and the powered device is a first powered device,
the system further comprises a second powered device circuit and a load shedding module,
the second powered device circuit is configured to receive the power and the network data from the power source and to provide at least part of the power and at least part of the network data to a second powered device,
the load shedding module is configured to determine a first load of the first powered device and a second load of the second powered device according to the at least part of the network data, resulting in load shedding data, and
the control module is further configured to disconnect the first powered device or the second powered device from the system, according to the load shedding data and the temperature data.

4. The system of claim 1, wherein:
the powered device circuit is a first powered device circuit and the powered device is a first powered device,
the system further comprises a second powered device circuit and a dynamic port priority allocation module,
the second powered device circuit is configured to:
receive the power and the network data from the power source; and
provide at least part of the power and at least part of the network data to a second powered device,
the dynamic port priority allocation module is configured to determine a first priority operation of the first powered device and a second priority operation of the second powered device according to the at least part of the power and the at least part of the network data, resulting in priority data, and
the control module is further configured to control the current limiting module to adjust the maximum limit of the current drawn from the power source by the first powered device circuit and the second powered device circuit, according to the priority data and the temperature data.

5. The system of claim 1, further comprising a power allocation module configured to determine power loss in the system according to the power and the network data, resulting in power loss data, wherein the control module is further configured to control the current limiting module to adjust the maximum limit of the current drawn from the power source by the powered device circuit according to the temperature data and the power loss data.

6. The system of claim 1, further comprising a power allocation module configured to determine power loss in the system according to the power and the network data, resulting in power loss data, wherein the control module is further configured to control adding current to be drawn from an additional power source by the powered device circuit according to the temperature data and the power loss data.

7. The system of claim 1, wherein the power source is a Power over Ethernet source.

8. The system of claim 1, wherein the network data includes the temperature data.

9. An apparatus, comprising:
a data communications interface configured to receive temperature data corresponding to a sensed temperature at a part of powered device and power sourcing equipment;
a first power and data communications interface configured to receive power and data and direct the power and the data to a second power and data communications interface; and
a current limiting module configured to limit current received at the first power and data communications interface according to the temperature data, and as a result limit the directed power.

10. The apparatus of claim 9, wherein the first power and data communications interface includes the data communications interface configured to receive temperature data.

11. The apparatus of claim 9, further comprising a load balancing module configured to:
determine a first load of a first powered device and a second load of a second powered device, resulting in load balancing data; and
control the limiting of the current received at the first power and data communications interface, according to the load balancing data and the temperature data.

12. The apparatus of claim 9, further comprising a load shedding module configured to:
determine a first load of a first powered device and a second load of a second powered device, resulting in load shedding data; and
disconnect the first powered device or the second powered device from the apparatus, according to the load shedding data and the temperature data.

13. The apparatus of claim 9, further comprising a dynamic port priority allocation module configured to:
determine a first priority operation of a first powered device and a second priority operation of a second powered device, resulting in priority data; and
control the limiting of the current received at the first power and data communications interface, according to the priority data and the temperature data.

14. The apparatus of claim 9, further comprising a power allocation module configured to:
to determine power loss in the powered device and power sourcing equipment, resulting in power loss data; and
control the limiting of the current received at the first power and data communications interface, according to the power loss data and the temperature data.

15. The apparatus of claim 9, further comprising a power allocation module configured to:
to determine power loss in the powered device and power sourcing equipment, resulting in power loss data; and
control adding current to be directed to the second power and data communications interface, according to the power loss data and the temperature data.

16. A method, comprising:
receiving, from a temperature sensor, a temperature at one or more of parts of power sourcing equipment and a plurality of powered devices, resulting in temperature data;
receiving Power over Ethernet at a first powered device circuit via a first uplink power source port, the first powered device circuit configured to provide at least part of the Power over Ethernet to a first powered device of the plurality of powered devices via a first downlink power source port;
receiving the Power over Ethernet at a second powered device circuit via a second uplink power source port, the second powered device circuit configured to provide at least part of the Power over Ethernet to a second powered device of the plurality of powered devices via a second downlink power source port;
limiting, by a current limiting module, current drawn from the power source by the first powered device circuit and the second powered device circuit;
determining, by a load balancing module, a first load of the first powered device and a second load of the second powered device, resulting in load balancing data; and
controlling, by a control module, the limiting of the current drawn from the power source by the first powered device circuit and the second powered device circuit, per circuit, according to the load balancing data and the temperature data.

17. The method of claim 16, wherein the load balancing data includes load shedding data and the method further comprises disconnecting, by the control module, the first powered device or the second powered device from the power sourcing equipment according to the load shedding data and temperature data.

18. The method of claim 16, further comprising:
determining, by a dynamic port priority allocation module, a first priority operation of the first powered device and a second priority operation of the second powered device, resulting in priority data; and
controlling, by the control module, the limiting of the current drawn from the power source by the first powered device circuit and the second powered device circuit, per circuit, according to the priority data, the load balancing data, and the temperature data.

19. The method of claim 16, further comprising:
determining, by a power allocation module, power loss in the one or more of parts of the power sourcing equipment and the plurality of powered devices, resulting in power loss data; and
controlling, by the control module, the limiting of the current drawn from the power source by the powered device circuit according to the power loss data, the load balancing data, and the temperature data.

20. The method of claim 16, further comprising:
determining, by a power allocation module, power loss in the one or more of parts of the power sourcing equipment and the plurality of powered devices, resulting in power loss data; and
controlling, by the control module, adding current to be drawn from an additional power source by the powered device circuit according to the power loss data, the load balancing data, and the temperature data.
